(19) United States
(12) Patent Application Publication
(10) Pub. No.: US 2020/0004227 A1
(43) Pub. Date: Jan. 2, 2020

(54) DEVICES AND METHODS FOR REQUESTING AND/OR SUPPLYING INFORMATION

(71) Applicant: CONNECT2ME PTE LTD, SINGAPORE (SG)

(72) Inventors: CHING YAU KANG, SINGAPORE (SG); XIANGDONG CHEN, SINGAPORE (SG)

(21) Appl. No.: 16/486,336

(22) PCT Filed: Aug. 24, 2017
(86) PCT No.: PCT/SG2017/050416

§ 371 Date: Aug. 15, 2019

(30) Foreign Application Priority Data
Feb. 17, 2017 (SG) 10201701300W
Jun. 6, 2017 (SG) 10201704619V
Aug. 24, 2017 (SG) PCT/SG2017/050416

(51) Int. Cl. G05B 19/4155; H04W 12/00; G06K 19/06; G06K 7/14; H04W 4/80

(52) U.S. Cl. CPC G05B 19/4155; H04W 12/0013; G05B 2219/2642; G06K 7/1417; H04W 4/80; G06K 19/06037

(57) ABSTRACT

According to embodiments of the present invention, devices and methods for controlling a target unit, and devices and methods for execution of an instruction in a data stream broadcast by an instructing unit are provided. The devices may include one or more modules such as a processing module, or a processor and a memory. A data stream including an identifying information for verification by the target unit and an instruction to the target unit for controlling the target unit may be broadcast. From the data stream that is received an identifying information included in the data stream may be assessed, and where verified, the instruction included in the data stream may be executed. According to further embodiments of the present invention, there may also be provided applications adapted to be installed on a device, and computer programs and computer program products.

### CROSS-REFERENCE TO RELATED APPLICATION

This application claims the benefit of priority of Singapore patent application Nos. 10201701300W, filed 17 Feb. 2017, and 10201704619V, filed 6 Jun. 2017, the contents being hereby incorporated by reference in their entirety for all purposes.

### TECHNICAL FIELD

Various embodiments relate to devices and methods for controlling a target unit, applications therefor, computer programs therefor, and computer program products therefor, and devices and methods for execution of an instruction in a data stream broadcast by an instructing unit.

### BACKGROUND

There are presently three (3) methods by which a smartphone may be used as a command and control device over other devices. The first method is by using Wi-Fi (and devices in communication with the smartphone via said Wi-Fi). However, the difficulties in using Wi-Fi are as follows: (i) requirement of IT knowledge to set-up, e.g., to configure the devices (e.g., switches and lights) as well as to configure the devices to connect to a gateway/router; (ii) a single point of failure at the gateway/router causes the entire network of devices to go down (or stop working) and it will no longer be able to control said devices via the smartphone; (iii) a mobile or smart device (e.g., phone) would not be able to use internet if gateway is not internet enabled; (iv) lack of security and privacy—devices that are Wi-Fi enabled will always broadcast their service set identifier (SSID) continuously and can be discovered when another computer is connected to the same network, thereby compromising device security; and (v) lack of speed in control—a smartphone takes 5 to 10 seconds to connect to a Wi-Fi network before it is able to exercise any command and control over devices connected to said Wi-Fi network (in other words, from no connection to control, at least 5 to 10 seconds are required for devices to be paired to the network).

The second method is by using a Bluetooth Radio in the smartphone. However, the difficulties in using Bluetooth are as follows: (i) when a first smartphone is connected to a device, a second smartphone cannot connect and control the same device; (ii) the maximum number of devices that can be controlled concurrently by a smartphone is limited to 7 to 8 devices; (iii) lack of security and privacy—bluetooth devices will have to always broadcast their ID (identifier) continuously so that they can be “discovered” by the smartphone for pairing, thereby compromising device security; (iv) lack of speed in control—the time taken for a smartphone to discover and initialise Bluetooth pairing to a device takes at least between 5 and 10 seconds (in other words, from no connection to control, at least 5 to 10 seconds are required for devices to be paired to other devices); and (v) no remote access.

The third method that overcomes some of the above limitations and enables a single command and control device to control many other devices is the use of infra-red (IR) transmissions. However, this method requires the smartphone to have an IR transmitter to be installed on the smartphone system, which not all smartphones are equipped with. Further, control of any device is based on line of sight.

In view of the above-mentioned limitations of known systems and methods, there is, therefore, need for a system, device and method for controlling at least one device, that is technically, cost efficient and addresses or overcomes at least one of the aforesaid limitations, as provided by various embodiments described herein.

### SUMMARY

The invention is defined in the independent claims. Further embodiments of the invention are defined in the dependent claims.

According to an embodiment, a device for controlling a target unit is provided. The device may include a processing module configured to broadcast a data stream including an identifying information for verification by the target unit and an instruction to the target unit for controlling the target unit.

According to an embodiment, a device for controlling a target unit is provided. The device may include a processor, and a memory coupled to the processor, the memory having stored therein instructions, which when executed by the processor, cause the processor to broadcast a data stream including an identifying information for verification by the target unit and an instruction to the target unit for controlling the target unit.

According to an embodiment, a device for execution of an instruction in a data stream broadcast by an instructing unit is provided. The device may include a processing module configured to assess an identifying information included in the data stream for verification of the data stream to be intended for the device, and further configured, in response to the verification, to execute the instruction comprised in the data stream to operate the device.

According to an embodiment, a device for execution of an instruction in a data stream broadcast by an instructing unit is provided. The device may include a processor, and a memory coupled to the processor, the memory having stored therein instructions, which when executed by the processor, cause the processor to assess an identifying information included in the data stream for verification of the data stream to be intended for the device, and, in response to the verification, execute the instruction comprised in the data stream to operate the device.

According to an embodiment, a method for controlling a target unit is provided. The method may include broadcasting a data stream including an identifying information for verification by the target unit and an instruction to the target unit for controlling the target unit.

According to an embodiment, a method for a device for executing an instruction in a data stream broadcast by an instructing unit is provided. The method may include assessing an identifying information included in the data stream for verification of the data stream to be intended for the device, and in response to the verification, executing the instruction comprised in the data stream to operate the device.

According to an embodiment, a device for controlling a target unit is provided. The device may include a processing module configured to broadcast a data stream in a radio frequency range, the data stream including an instruction to the target unit for controlling the target unit.

According to an embodiment, a device for execution of an instruction in a data stream broadcast in a radio frequency range by an instructing unit is provided. The device may include a processing module configured to execute the instruction included in the data stream to operate the device.

According to an embodiment, a method for controlling a target unit is provided. The method may include broadcasting a data stream in a radio frequency range, the data stream including an instruction to the target unit for controlling the target unit.

According to an embodiment, a method for a device for executing an instruction in a data stream broadcast in a radio frequency range by an instructing unit is provided. The method may include executing the instruction comprised in the data stream to operate the device.

According to an embodiment, an application adapted to be installed on a device is provided. The application may include processor-executable instructions for execution on the device to carry out a method as described herein for controlling a target unit.

According to an embodiment, a computer program or a computer program product is provided. The computer program or computer program product may include instructions which, when executed by a computing device, cause the computing device to carry out a method as described herein for controlling a target unit.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic diagram for a device for controlling a target unit, according to various embodiments.

FIG. 1B shows a schematic diagram for a device for execution of an instruction in a data stream broadcast by an instructing unit, according to various embodiments.

FIG. 1C shows a schematic diagram for a device, according to various embodiments.

FIG. 1D shows a method for controlling a target unit, according to various embodiments.

FIG. 1E shows a flow chart illustrating a method for a device for executing an instruction in a data stream broadcast by an instructing unit, according to various embodiments.

FIG. 1F shows a schematic diagram for a device for controlling a target unit, according to various embodiments.

FIG. 1G shows a schematic diagram for a device for execution of an instruction in a data stream broadcast in a radio frequency range by an instructing unit, according to various embodiments.

FIG. 1H shows a method for controlling a target unit, according to various embodiments.

FIG. 1I shows a method for a device for executing an instruction in a data stream broadcast in a radio frequency range by an instructing unit, according to various embodiments.

FIG. 1J shows a schematic diagram for an application, according to various embodiments.

FIG. 1K shows a schematic diagram for a computer program or a computer program product, according to various embodiments.

FIG. 2 shows a flow chart illustrating an application (app) decision process, according to various embodiments.

FIG. 3 shows a flow chart illustrating a process flow at a receiving device, according to various embodiments.

FIG. 4A shows images of screens for an application (app) of various embodiments.

FIG. 4B shows examples of QR codes for different devices.

FIG. 5 shows examples of apparatus forming part of an ecosystem of various embodiments.

FIGS. 6A and 6B show schematic diagrams illustrating parts of ecosystems of various embodiments.

FIG. 7 shows a schematic diagram illustrating flow charts for a method for generating a header, according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

As used herein, the term “and/or” includes any and all combinations of one or more of the associated listed items.

Smart home automation is growing every year with projection of global demand of USD51Bn in year 2025. There are gaps in the Internet of things (IoT) for smart home and control. Various embodiments may provide an ecosystem of technology for smart control of devices.

Various embodiments may relate to wireless control over devices, for example, to control devices via a smartphone. The phone broadcast may be an RF (radio frequency) broadcast.

Various embodiments may employ Bluetooth technology (e.g., based on Bluetooth 4.1) which may allow many-to-many communication channels. Another suitable technology may include the WiFi headless technology. Various embodiments may employ a modified protocol of the above-mentioned technology.

Various embodiments may provide a single data push-out, meaning that the relevant information and instruction may be provided in one data stream, as compared to 2-packet data which results in lower speed and integrity, and more noise.

In a non-limiting example of various embodiments, as an initial step, a receiver device (Rx) may be registered with a smartphone app (application) via scanning of an associated label or identifying code (for example, an optical code/label, e.g., a QR code (Quick Response code)). The device may provide one or more information to the smartphone application via the QR code, such as the device ID (identifier) (DID), the nature of the device, the company of origin of the device, and the pulse width modulation (PWM) connection information or UART (universal asynchronous receiver/transmitter) output. Upon successfully scanning the QR code and acquiring information therefrom, the smartphone application creates a representation or a user interface of the device in the smartphone application. When the representation of the device is activated in the smartphone application, the smartphone (as a transmitter device) prepares and transmits a data package. The receiver device listens to BLE (Bluetooth Low Energy) or iBeacon, as the case may be, for transmissions from the smartphone. Upon receiving such a data package, the receiver device recognizes the header and performs a decryption of the data package using the encryption key provided. After the decryption is complete, the receiver device checks whether the device ID that has been decrypted from the data package corresponds to the actual device ID of the receiver device. Once this has been verified, the receiver device executes the instructions or commands contained in the data package.

Various embodiments may provide one or more of the following: (1) one touch solution; (2) no network set-up; (3) easy to use and no complicated setup (no gateway, no IT specialised knowledge); (4) unlimited connection—allows multiple smart devices (e.g., smartphones) to control any devices at any time without the need for the devices to be internet ready; (5) support many (devices) to many (devices) connection; (6) no one point of failure in the system or set-up; (7) fast and easy to customize and control (e.g., fast to control any device, group devices and make schedule); (8) fast connection within 2 seconds; (9) use of rolling encryption key; and (10) silent RF (radio frequency) signature.

As compared to known systems and methods using Wi-Fi, various embodiments may provide many to many connection, and remote access. As compared to known systems and methods using Bluetooth, various embodiments may enable a phone to still be able to use Wi-Fi for internet, and there is no one point of failure in the system.

Various embodiments may be employed in various ecosystems or facility management, for example, involving homes, cinemas, halls, hotels, etc.

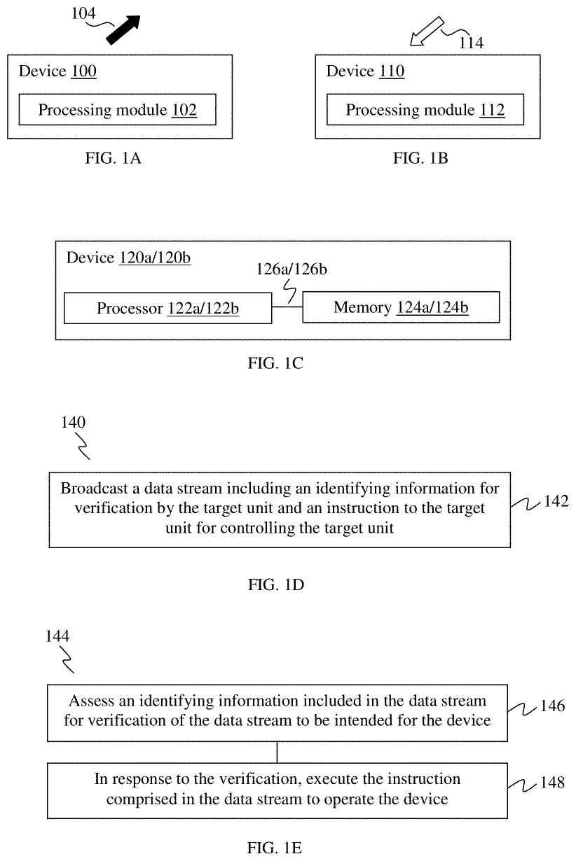

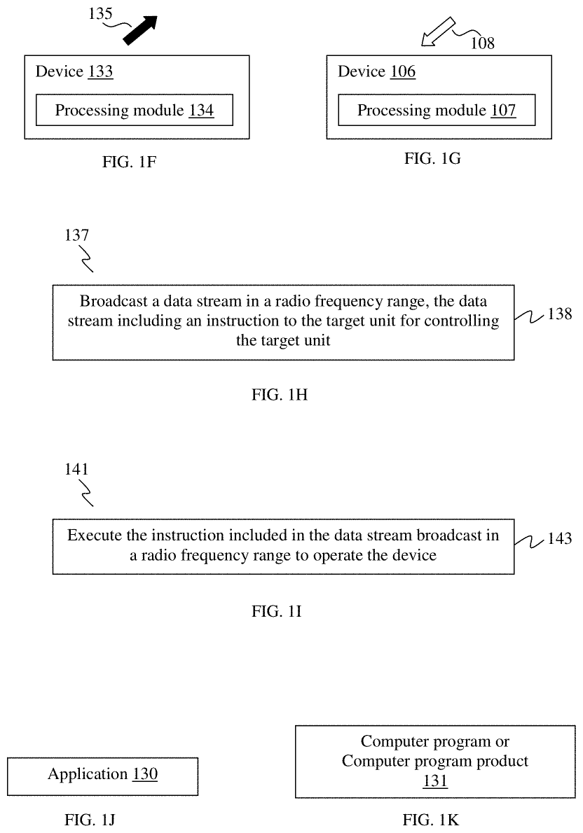

FIG. 1A shows a schematic diagram for a device 100 for controlling a target unit, according to various embodiments. The device 100 includes a processing module 102 configured to broadcast a data stream (represented by arrow 104) including an identifying information for verification by the target unit and an instruction to the target unit for controlling the target unit.

In other words, a device 100 for controlling (or configured to control) a target unit (or receiving device), or for controlling an operation of the target unit, may be provided. Accordingly, the device 100 may be a controlling device while the target unit may be a controlled device. The device 100 may enable wireless control over the target unit. The device 100 may be an instructing device which may provide one or more instructions to the target unit. The device 100 may be used as part of a command and control system or communication, meaning, for example, that the device 100 may be a command and control device. The device 100 may be a communication device. In various embodiments, the device 100 may be a phone (e.g., a smartphone), a tablet (computer), etc.

The device 100 may include a processing module 102 configured to broadcast (e.g., wirelessly or via wireless communication), over the air, a data stream 104 having therein an identifying information to be assessed and/or verified by the target unit, as well as an instruction to the target unit so as to control the target unit or an operation thereof. The data stream 104 may include a portion containing the identifying information and another portion containing the instruction. Both portions of the data stream 104 may be separate portions. The processing module 102 may include a transmitting module configured to broadcast the data stream 104.

In the context of various embodiments, the term “identifying information” may refer to an identifying (or identifier) code or number. The identifying information may act as an identification or verification to the processing module 102 that the data stream 104 is intended for the target unit. The identifying information may include the device ID (identifier) of the target unit, which may be (uniquely) associated with the target unit, and/or the header (or header section) of the data stream 104.

In the context of various embodiments, different respective device ID or identifier may be (uniquely) associated with respective target units. As a non-limiting example, a first data stream for a first target unit may include a first device ID associated with the first target unit, while a second data stream for a second target unit may include a second device ID associated with the second target unit, where the first and second device IDs are different to one another, e.g., in terms of the identifying value.

In the context of various embodiments, the term “broadcast” may mean relaying of data stream or data signal from one device directly to another device, without having to pass through an intermediate element or device (e.g., a network node, a server, a gateway, etc.). The term “broadcast” may further mean relaying of data stream or data signal from one device directly to another device, without the requirement for “pairing” of both devices to each other in order to allow a communication exchange (e.g., exchange of information) between both devices, as required in “classical” Bluetooth protocol. Such “pairing” may limit both devices to a one-to-one connection such that during the communication exchange between both devices, a third device is unable to initiate or conduct another communication exchange with either of both devices. In contrast, for broadcast between two devices, each device may be available for communication with a plurality of devices, for example, one-to-many, many-to-one, and many-to-many communications. Accordingly, it should be appreciated that in a “broadcast” communication between two devices, no connection or pairing between the two devices may be necessary or required for a communication exchange.

The data stream 104 may be broadcast as part of an ad-hoc communication between the device 100 and the target unit. In this way, the processing module 102 may be configured to broadcast the data stream 104 to the target unit on an ad-hoc basis. This may mean that the device 100 may control the target unit via discrete ad-hoc broadcast of one or more data streams.

In the context of various embodiments, the data stream 104 may be in the RF (radio frequency) range, meaning that the data stream 104 may be an RF signal. The data stream 104 may be broadcast via an RF (radio frequency) transmitter (e.g., an RF radio) of the device 100. This may mean that the data stream broadcast may be an RF broadcast.

In the context of various embodiments, for a data stream as described herein, the frequency for the data stream, as an RF signal, may be dependent on the device broadcasting the signal, for example, the 2.4 GHz ISM (industrial, scientific and medical) band for smartphones. In various embodiments, the RF signal broadcast may be between about 2.4 GHz and about 2.4835 GHz, corresponding to the 2.4 GHz ISM band, or at 5 GHz.

In the context of various embodiments, the term “data stream” may mean a data signal, a data packet, a broadcast data, a broadcast (data) stream, or a broadcast (data) signal.

In the context of various embodiments, the term “verify” and any variation of the word (e.g., verification) may mean validation or authentication. A data stream that is verified by the target unit means that the data stream is compatible with and is intended for the data stream such that the target unit may then process the data stream and act on any instruction contained in the data stream.

In the context of various embodiments, the term “unit” in the context of “target unit” may be used interchangeably with any of the following: device, apparatus, article, object, item, or the like, and the term “unit” is used to clearly identify the target unit from the (originating) device configured to control the target unit.

In the context of various embodiments, the target unit may be a passive device, meaning that the target unit may be a non-broadcasting or non-transmitting device. In other words, the device may not be capable of broadcasting or transmitting a signal (e.g., an RF signal). This may mean that the communication between the device 100 and the target unit is unidirectional (i.e., in a single direction) from the device 100 to the target unit.

In the context of various embodiments, the target unit may be a wireless device.

In the context of various embodiments, the target unit may include an electrical device or appliance, for example, a switch, a light source, an air-conditioner, an electronic lock, etc.

In various embodiments, the processing module 102 may be configured to generate the data stream 104 for broadcast. The processing module 102 may include a generating module for generating the data stream 104.

The processing module 102 may be configured to broadcast the data stream 104 further including a timing information for verification by the target unit. In other words, the data stream 104 broadcast by or from the processing module 102 or the device 100 may include the identifying information, the instruction and the timing information. The timing information may mean information that is related to time, for example, the time the data stream 104 is generated and/or broadcast or any time that may uniquely identify the (specific) data stream 104 that is being broadcast to the target unit. The timing information accompanying the data stream 104 may be stored in or by the target unit.

As a non-limiting example, the timing information may be in the form of “t+n” (where n=0, 1, 2, . . . ), for example, the initial (or first) data stream may include a timing information “t”, which may be incremented by 1 (one) unit (e.g., 1 second) for each subsequent data stream that is broadcast by the device 100. Each subsequent data stream may refer to data streams broadcast to any target unit or to data streams broadcast to a specific target unit.

The timing information may provide an order or sequence, in time, of various data streams broadcast by the device 100. This may provide a way for the target unit to recognise the latest or most recent data stream broadcast by the device 100 so that the target unit may act upon the respective instruction in successive data streams in sequence or order.

Including a timing information may provide a safeguard against potential intrusion by an unauthorised user. For example, an authorised user may use the device 100 to broadcast a first data stream at a particular time, t₁, where this timing information may be part of the first data stream, to control the target unit. Subsequently, a second data stream may be broadcast, under control of the authorised user, at another particular time, t₂, where this timing information may be part of the second data stream. Assuming an unauthorised user who may attempt to hijack the operation of the target unit, the unauthorised user may capture the first data stream. Assuming the unauthorised user then broadcasts the captured first data stream with the timing information, t₁, to the target unit at a further time, t₃, subsequent to t₂, the target unit, having received (and acted on) the second data stream with the timing information, t₂, would be able to recognise that the captured first data stream has a timing information, t₁, that is prior to, t₂, and therefore is out of sequence. Consequently, the target unit may recognise the captured first data stream as an invalid data stream and accordingly not act on the instruction contained therein.

In various embodiments, the processing module 102 may be further configured to encrypt the data stream 104 prior to broadcasting the data stream 104. This may mean that the data stream 104 as received by the target unit may be in an encrypted form. The data stream 104 may be encrypted based on a rolling encryption key technique. The data stream 104 may further include decryption information for the target unit to enable the target unit to decrypt the data stream 104.

In various embodiments, the processing module 102 may be configured to retrieve, from the target unit, an identifier (e.g., device ID) (uniquely) associated with the target unit.

In various embodiments, the processing module 102 may be configured to retrieve information from an optical code associated with the target unit. For example, the device 100 may read or scan the optical read (e.g., via an optical (imaging) unit of the device 100) and the processing module 102 may then process the reading to extract information that may be embedded within the optical code. The optical code may act as an identification for the target unit. The information corresponding to the target unit that may be retrieved may include but not limited to, the device ID (uniquely) associated with the target unit, the nature of the target unit (e.g., the type of target unit or its function(s)), the origin of the target unit (e.g., the source or manufacturer of the target unit), etc. The optical code may include a QR code (Quick Response Code) or a light Morse code. However, it should be appreciated that identification other than in the form of an optical code may also be employed.

In various embodiments, the identifying information may include a virtual identifier associated with (or shared by or common to) a plurality of target units, and the processing module 102 may be further configured to broadcast the data stream 104 to the plurality of target units simultaneously. A virtual identifier may act as an effective ID (rather than the actual ID for each target unit) to identify a target unit or a group of target units. The virtual identifier may act as an interface to the actual ID for a target unit.

In various embodiments, the device 100 may be configured to be in an RF (radio frequency) silent mode (or state or condition) prior to broadcasting of the data stream 104.

In the context of various embodiments, a device in an “RF silent mode” means that the device, while powered on, is in a non-broadcasting or non-transmitting mode (or state or condition) for an RF signal. In other words, the device may be in an RF silent mode of operation where there is no broadcast of any RF signal. For example, prior to the data stream 104 being broadcast, the device 100 may not broadcast or transmit any RF signal. As a non-limiting example, the device 100, when powered on, may broadcast RF signals or data streams on an intermittent basis (e.g., on demand or ad-hoc basis) as compared to known devices which continuously send out RF signals once powered on. For example, device 100 may maintain RF silence when there is no instruction or command to be broadcast from the device 100 to the target unit. This may mean that the device 100 may be configured to be in an RF silent mode, other than when broadcasting the data stream 104 or when communicating with the target unit. There is no network connection between the device 100 and the target unit, and instructions may be sent to the target unit as and when required. In this way, in various embodiments, RF silence may be maintained between or among all devices/units when no instruction or data stream is being broadcast or sent out. In this way, communication between the device 100 and target unit may be ad-hoc. As such, by maintaining RF silence, the request for control from the device 100 to the target unit may be on an ad-hoc basis. Further, by maintaining RF silence, the presence of RF controllable devices may not be made known to any person. In other words, anyone may be prevented from knowing that there may be RF controllable devices in the environment or ecosystem.

In the context of various embodiments, the processing module 102 may be configured to broadcast the data stream 104 in compliance with a Bluetooth protocol (e.g., Bluetooth Low Energy; BLE) or a Wi-Fi protocol (e.g., Wi-Fi headless). As a non-limiting example, the data stream 104 may be Bluetooth-compliant. This may mean that the data stream 104 may have a structure or profile that may be Bluetooth-compliant, or in accordance with Bluetooth protocol. As a non-limiting example, the data stream 104 may be BLE-compliant or having a BLE data structure, for example, having an iBeacon profile.

In various embodiments, the device 100 may further include an application installed on the device 100, the application including processor-executable instructions for execution by the processing module 102, wherein the processing module 102 may be configured to execute instructions for broadcasting the data stream 104 in response to activation of a user interface of the application. The user interface may include one or more command features (e.g., buttons). For example, the user interface may be activated in response to a user of the device 100 pressing the user interface (button) in the application. In various embodiments, the processing module 102 may be further configured to generate the data stream 104 and/or to encrypt the data stream 104 in response to activation of the (or another) user interface (button) of the application. The processor-executable instructions may also include instructions for one or more of the other operations of the device 100 as described herein.

FIG. 1B shows a schematic diagram for a device 110 for execution of an instruction in a data stream (represented by arrow 114) broadcast by an instructing unit, according to various embodiments. The device 110 includes a processing module 112 configured to assess an identifying information included in the data stream 114 for verification of the data stream 114 to be intended for the device 110, and further configured, in response to the verification, to execute the instruction comprised in the data stream 114 to operate the device 110.

In other words, a device 110 may be provided, for executing or configured to execute an instruction in a data stream 114 from an instructing unit which is configured to broadcast the data stream 114. The data stream 114 may be (directly) received by the device 110 from the instructing unit. Accordingly, the device 110 may be a device to be controlled. The instructing unit may be the device (e.g., 100, FIG. 1A) as described herein for controlling a target unit. In various embodiments, the device 110 may be a wireless device. The device 110 may include an electrical device or appliance, for example, a switch, a light source, an air-conditioner, an electronic lock, etc.

The device 110 may include a processing module 112 that may verify that the data stream 114 is intended for the device 110 by assessing an identifying information included in the data stream 114, and, when verified, to cause the device 110 to operate in a manner in accordance with an instruction contained in the data stream 114. For example, this may mean that the processing module 112 may process the data stream 114, for example, broadcast (e.g., wirelessly or via wireless communication) from an instructing unit. The processing module 112 may include a receiving module configured to receive the data stream 114 broadcast over the air. The processing module 112 may then assess an identifying information included in the data stream 114 to determine whether the data stream 114 is intended for the device 110. Where the processing module 112 recognises the identifying information, the processing module 112 verifies the data stream as intended for the device 110. In response to the verification, the processing module 112 may then process the data stream 114 and execute the instruction in the data stream 114 to operate the device 110 in a manner in compliance with the instruction. Accordingly, it should be appreciated that the operation of the device 110 may be controlled by means of the data stream 114 received, in accordance with the instruction contained therein.

In various embodiments, the device 110 may listen for data streams available on air, for example, for a data stream that may be compatible with the device 110.

The data stream 114 may be broadcast by the instructing unit as part of an ad-hoc communication between the device 110 and the instructing unit.

In the context of various embodiments, the data stream 114 may be in compliance with a Bluetooth protocol (e.g., Bluetooth Low Energy; BLE) or a Wi-Fi protocol (e.g., Wi-Fi headless). As a non-limiting example, the data stream 114 may be Bluetooth-compliant. This may mean that the data stream 114 may have a structure or profile that may be Bluetooth-compliant, or in accordance with Bluetooth protocol. As a non-limiting example, the data stream 114 may be BLE-compliant or having a BLE data structure, for example, having an iBeacon profile.

In the context of various embodiments, the term “unit” in the context of “instructing unit” may be used interchangeably with any of the following: device, apparatus, article, object, item, or the like, and the term “unit” is used to distinguish the instructing unit from the device 110.

The processing module 112 may be further configured to verify a timing information included in the data stream 114. The timing information may be verified prior to execution of the instruction. The processing module 112 may retrieve or extract the timing information included in the data stream 114 prior to verification of the timing information. The processing module 112 or a memory (as part of or separate from the processing module 112) may store the timing information.

In various embodiments, the processing module 112 may be further configured, in response to the data stream 114 being in an encrypted form, to retrieve decryption information from the date stream 114 for decrypting (or to decrypt) the data stream 114.

In various embodiments, the device 110 may include an optical code capable of being read (for information to be retrieved based on the optical code).

In various embodiments, the device 110 or the processing module 112 may be configured to simultaneously interact with a plurality of data streams broadcast by respective instructing units. This may mean that the device 110 may be capable of communicating with two or more instructing units at the same time. The device 110 may assess the respective identifying information included in the respective data streams received, and if verified, may then execute the respective instructions included in the respective data streams to operate the device 110 accordingly.

In various embodiments, a virtual identifier may be defined for the device 110, the virtual identifier being common to at least one other device (to be controlled).

In various embodiments, the device 110 may be a passive device. This may mean that the device 110 may be a non-broadcasting or non-transmitting device. In other words, the device 110 may not be capable of broadcasting or transmitting a signal (e.g., an RF signal). This may mean that the communication between the device 110 and the instructing unit is unidirectional (i.e., in a single direction) from the instructing unit to the device 110.

As a non-limiting example, the device 110 may receive a data stream 114 broadcast by an instructing unit and assess a header of the data stream 114. If the device 110 verifies the header (or recognise the header) to be intended for or compatible with the device 110, the device 110 may then assess the checksum of the data stream 114 and may proceed to decrypt the data stream (which may be encrypted) 114. The device 110 may then proceed to assess whether an ID (identifier) included in the data stream 114 may be (uniquely) associated with the device 110. If the device 110 verifies the ID, the device 110 may then proceed to assess the timing information included in the data stream 114. If the device 110 verifies the timing information, the device 110 may then proceed to execute the instruction included in the data stream 114 to operate the device 110 in accordance with the instruction. The header and the identifier may be part of the identifying information included in the data stream 114.

FIG. 1C shows a schematic diagram for a device 120a, 120b, according to various embodiments. The device 120a, 120b may include a processor 122a, 122b and a memory 124a, 124b coupled to the processor 122a, 122b (represented by the line 126a, 126b), for example, physically coupled and/or electrically coupled.

In various embodiments, for a device 120a for controlling (or configured to control) a target unit, the device 120a includes a processor 122a and a memory 124a having stored therein instructions, which when executed by the processor 122a, cause the processor 122a to broadcast a data stream including an identifying information for verification by the target unit and an instruction to the target unit for controlling (an operation of) the target unit.

In various embodiments, for a device 120b for execution of (or configured to execute) an instruction in a data stream broadcast by an instructing unit, the device 120b includes a processor 122b and a memory 124b having stored therein instructions, which when executed by the processor 122b, cause the processor 122b to assess an identifying information included in the data stream for verification of the data stream to be intended for the device, and, in response to the verification, execute the instruction included in the data stream to operate the device. The data stream may be (directly) received by the device 120b from the instructing unit.

FIG. 1D shows a method 140 for (or of) controlling a target unit, according to various embodiments. At 142, a data stream including an identifying information for verification by the target unit and an instruction to the target unit for controlling (an operation of) the target unit is broadcast (e.g., wirelessly or via wireless communication).

The method 140 may further include generating the data stream for broadcasting.

In various embodiments, at 142, the data stream that is broadcast may further include a timing information for verification by the target unit.

In various embodiments, the data stream may be encrypted prior to broadcasting the data stream at 142.

In various embodiments, at 142, the data stream that is broadcast may further include a decryption information.

In various embodiments, the identifying information may include a virtual identifier associated with (or shared by or common to) a plurality of target units, and, at 142, the data stream may be broadcast to the plurality of target units simultaneously.

In various embodiments, the method 140 may be RF silent prior to broadcasting the data stream at 142. This may mean that no RF signal is broadcast or transmitted prior to the data stream being broadcast.

In various embodiments, at 142, the data stream may be broadcast in compliance with a Bluetooth protocol (e.g., Bluetooth Low Energy; BLE) or a Wi-Fi protocol (e.g., Wi-Fi headless). As a non-limiting example, the data stream may be Bluetooth-compliant. This may mean that the data stream may have a structure or profile that may be Bluetooth-compliant, or in accordance with Bluetooth protocol. As a non-limiting example, the data stream may be BLE-compliant or having a BLE data structure, for example, having an iBeacon profile.

In various embodiments, the method 140 may further include retrieving information from an optical code associated with the target unit prior to broadcasting the data stream at 142.

In various embodiments, the method 140 may further include retrieving, from the target unit, an identifier (e.g., device ID) (uniquely) associated with the target unit, for example, prior to broadcasting the data stream at 142.

In various embodiments, the method 140 may further include generating a user interface on a device for controlling the target unit, for example, prior to broadcasting the data stream at 142. The user interface may be part of an application installed on the device to be used for controlling the target unit.

FIG. 1E shows a flow chart 144 illustrating a method for a device for (or of) executing an instruction in a data stream broadcast by an instructing unit, according to various embodiments. This may mean that a method of executing an instruction in a data stream broadcast by an instructing unit may be provided, the method to be performed by or on a device.

At 146, an identifying information included in the data stream is assessed for verification of the data stream to be intended for the device. The data stream may be broadcast by the instructing unit in compliance with a Bluetooth protocol (e.g., Bluetooth Low Energy; BLE) or a Wi-Fi protocol (e.g., Wi-Fi headless). As a non-limiting example, the data stream may be Bluetooth-compliant. This may mean that the data stream may have a structure or profile that may be Bluetooth-compliant, or in accordance with Bluetooth protocol. As a non-limiting example, the data stream may be BLE-compliant or having a BLE data structure, for example, having an iBeacon profile.

At 148, in response to the verification, the instruction included in the data stream is executed to operate the device.

In various embodiments, the method may further include verifying a timing information included in the data stream, for example, prior to executing the instruction at 148.

In various embodiments, the method may further include, in response to the data stream being in an encrypted form, retrieving decryption information from the date stream for decrypting (or to decrypt) the data stream.

In various embodiments, the method may further include simultaneously interacting with a plurality of data streams broadcast by respective instructing units.

While the method described above is illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

FIG. 1F shows a schematic diagram for a device 133 for controlling (or configured to control) a target unit, according to various embodiments. The device 133 includes a processing module 134 configured to broadcast a data stream (represented by arrow 135) in a radio frequency range, the data stream 135 including an instruction to the target unit for controlling the target unit.

FIG. 1G shows a schematic diagram for a device 106 for execution of (or configured to execute) an instruction in a data stream (represented by arrow 108) broadcast in a radio frequency range by an instructing unit, according to various embodiments. The device 106 for includes a processing module 107 configured to execute the instruction included in the data stream to operate the device.

FIG. 1H shows a method 137 for (or of) controlling a target unit, according to various embodiments. At 138, a data stream is broadcast in a radio frequency range, the data stream including an instruction to the target unit for controlling the target unit.

FIG. 1I shows a method 141 for a device for (or of) executing an instruction in a data stream broadcast in a radio frequency range by an instructing unit, according to various embodiments. At 143, the instruction included in the data stream is executed to operate the device.

FIG. 1J shows a schematic diagram for an application (“App” or “app”) 130, according to various embodiments. The application 130 (e.g., mobile app) is adapted to be installed on a device (for example, a mobile device, a smart device (e.g., a smart mobile device) or a wireless communication device). The application 130 includes processor-executable instructions for execution on the device to carry out a method as described herein for controlling a target unit, for example, method 137, 140.

In various embodiments, the processor-executable instructions may include an instruction to retrieve information from (or corresponding to) an optical code associated with the target unit. The information may include, among others, the ID (uniquely) associated with the target unit.

In various embodiments, the processor-executable instructions may further include an instruction, in response to the information retrieved, to generate a user interface corresponding to the target unit. The user interface may be or may provide a representation of the target unit. The user interface may include one or more command buttons, which when activated by a user, may carry out corresponding instructions for controlling a target unit.

FIG. 1K shows a schematic diagram for a computer program or a computer program product 131, according to various embodiments. The computer program or the computer program product 131 includes instructions which, when executed by a computing device, cause the computing device to carry out a method as described herein for controlling a target unit, for example, method 137, 140. The computer program product 131 may be or may include a computer-readable storage medium.

In the context of various embodiments, it should be appreciated that a reference to a “transmitter” or a “transmitting device” may include a reference to a “broadcasting device”.

It should be appreciated that descriptions in the context of any one of the devices, the methods, the applications, the computer programs and the computer program products described herein may correspondingly be applicable in relation to any one of the others described herein.

In the context of various embodiments, a device or unit to be controlled or being controlled may mean that an operation or functionality of the device or unit may be controlled. As non-limiting examples, for a light source being controlled, switching on/off of the light source, or a lighting intensity and/or lighting colour emitted therefrom, may be controlled.

In the context of various embodiments, communication between devices or units described herein may be within a range extending up to between 10 meters and 100 meters, depending on the signal strength. It should be appreciated that communication between devices within 10 meters or less of each other is possible.

Various embodiments may also provide a device for broadcasting a data stream to a receiving unit, the device including a generating module configured to generate a header for the data stream based on an identifier (or identifying information) associated with the receiving unit, and a processing module configured to broadcast the data stream including the header. The identifier may be uniquely associated with the receiving unit.

Various embodiments may also provide a device for receiving a data stream from a transmitting unit, the device including a generating module configured to generate a filtering parameter based on an identifier (or identifying information) associated with the device, and a processing module configured, in response to a data stream received from the transmitting unit including a header matching the filtering parameter, to process the data stream. The identifier may be uniquely associated with the receiving unit.

In various embodiments, a smartphone may be used as an instructing device. The smartphone may act as a transmitter and may broadcast encrypted data through the RF radio of the smartphone. The device to be controlled may include a receiver to receive the signal (including data) broadcast from the smartphone. The receiver may be capable of decrypting the data, processing the data, and executing any command instructions contained in said data.

The RF radio broadcast from the smartphone may use the Bluetooth protocol standard to broadcast information to the device(s) to be controlled. The receiving device (i.e., the controlled device) may also have a Bluetooth protocol standard receiver to receive the signal transmitted from the smartphone. Each receiver may have a unique device ID and may react to the signal broadcast from the smartphone as required.

The signal transmitted from the smartphone may include various pieces of data or information, which may be encrypted. The encrypted data that may be included in the signal may include, but not limited to, the receiving device's unique ID, one or more commands and/or instructions, encryption (information), checksum, and timer (or timing information).

The encryption applied to the encrypted data may be or may have a rolling encryption key based on time, to minimise or prevent hijacking. For example, this may involve a combination of encryption and checksum, which may be varied over time. The receiver at the receiving device may decrypt the data and may have the ability to continue to decrypt the data even after the receiving device's electrical power is restarted or interrupted (e.g., turned off and turned on again). The smartphone may generate a random set of encryption keys whereby the receiver may recognise the embedded key and decrypt the data.

In various embodiments, the receiver may also be programmed with a virtual ID whereby any device that is programmed with the same virtual ID may be controlled using a single broadcast or transmission from the smartphone. The virtual ID may be sent to the receiving device by the smartphone via the RF broadcast/transmission. The receiver may also include a timer program that is capable of receiving a single RF broadcast/transmission from the smartphone. The timer program may be used for verification of the timing information received and/or to keep track of the timing information.

In various embodiments, the smartphone may be associated with a device via a QR code, Light Morse code, RF beacon ID, or any other similar means. For example, the smartphone may read the QR code corresponding to the device to be controlled to retrieve information therefrom. Upon association, a smartphone app may be activated by a user or upon an event occurring. Within approximately 2 seconds from turning on the Bluetooth radio to commence broadcast or transmission of the signal containing data, a user may be able to establish control over the device(s) that is to be controlled.

Various embodiments of the devices, the (eco)systems and the methods may provide one or more of the following.

(i) No prerequisite IT knowledge is needed for the configuration of the instructing device (e.g., smartphone) and/or the devices to be controlled.

(ii) The device(s) to be controlled rely on a passive receiver, i.e., there is no broadcasting of any signal from the device(s) in the 2.4 Ghz RF range, or any other range.

(iii) Command and control over the device(s) is via discrete ad-hoc broadcasts or transmissions of commands from the smartphone as opposed to continuous signal transmissions.

(iv) The broadcast or transmission containing the commands to the device from the smartphone may be encrypted with a rolling encryption key.

(v) The smartphone may be able to speedily establish control over the device, e.g., within 2 secs for a single device.

(vi) The method may provide a (eco)system that may allow for control of one or more devices by a single smartphone, and/or control of a device via one or more smartphones.

(vii) There is no need to hack the smartphone operating system or to perform any physical (or hardware) modifications to enable the method and system of various embodiments to be achieved, which gives rise to ease of installation and maintenance and ease of use.

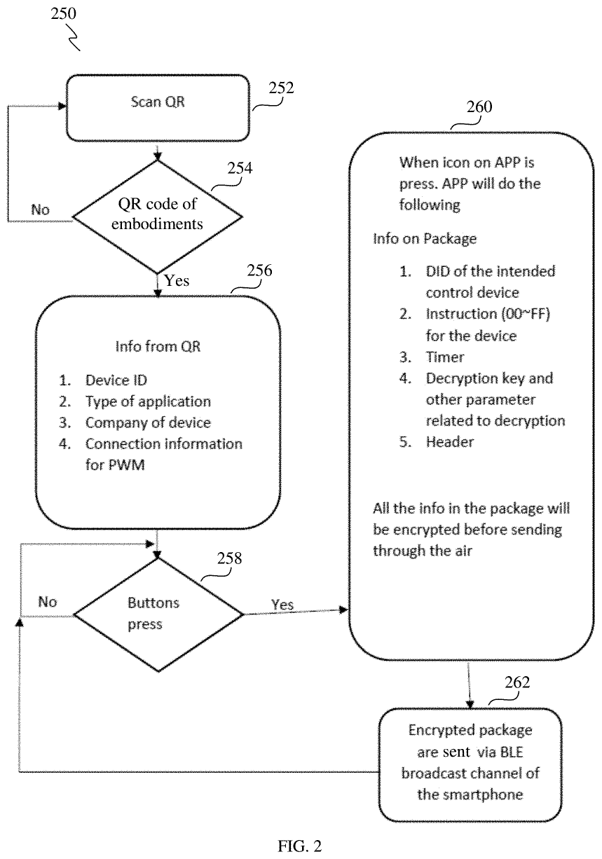

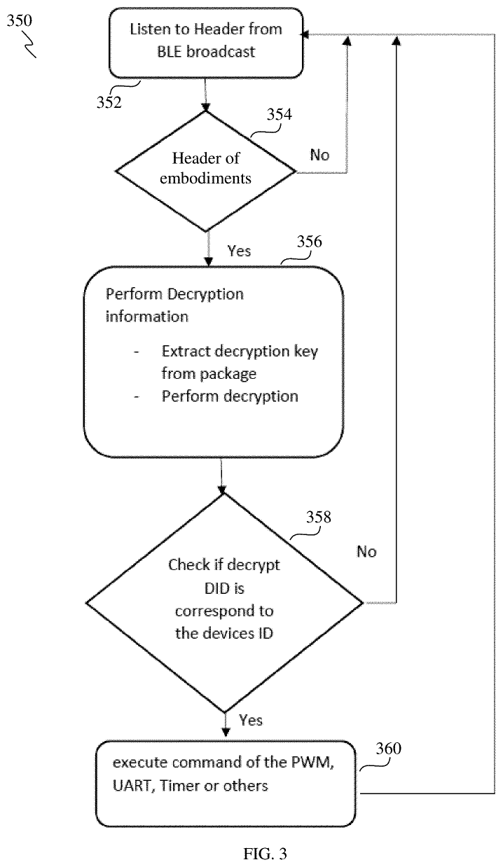

FIG. 2 shows a flow chart 250 illustrating an application (app) decision process, according to various embodiments, illustrating a mobile device or a smart device (e.g., a smartphone) application decision flow chart process. As an initial step, at 252, the device to be controlled (e.g., receiving device or target unit) may be registered with a smartphone app via the scanning of a QR code associated with the device. Where the QR code is recognised, e.g., at 254, information may then be retrieved from the QR code.

The device may provide information to the smartphone app via the QR code, including, for example (as illustrated at 256), the device ID, the nature of the device (e.g., the type of light, such as a normal 2-state On-Off light, Dimming light, multi-colour-changing light, for example). Beside lights, the QR code may also describe the nature of the device, for example, whether it is a TV remote control, an auto-gate, an auto-curtain, or a safe box. Other devices to be controlled may also be possible. The QR code may also include or embed information such as the company of origin of the device, the pulse width modulation (PWM) connection information or the UART (universal asynchronous receiver/transmitter) output. PWM may be used as a drive control for an On-Off switch or for a dimming switch. For a dimming switch, the PWM may have a range of 0 to 255 steps. By combining different configurations of the PWM, a user may be able to control colours of a light, motors of devices or other electrical and mechanical devices.

Upon successfully scanning the QR code and acquiring information therefrom, the smartphone application may create a representation of the device in the smartphone app. When the representation of the device is activated in the smartphone application, for example, where a corresponding user interface or button is pressed, the smartphone may prepare and transmit a data package (or data stream), as shown at 258 and 260. The daa package may include, but not limited to, the following: (i) device ID (DID) (of the intended device to be controlled), (ii) instructions/commands (00˜FF) for the device, (iii) timer or timing information, (iv) decryption key and other parameters related to decryption, and (v) header. In various embodiments, the header may include a device ID or a group virtual ID (meaning a virtual ID that may be applicable to a group of devices).

As illustrated at 260, all the information in the data package may be encrypted before being broadcast or sent. The encrypted package may be broadcast via Bluetooth Low Energy (BLE) or iBeacon BLE broadcast channel of the smartphone, at 262.

FIG. 3 shows a flow chart 350 illustrating a process flow at a receiving device (or at a receiver of a device), according to various embodiments. As a passive receiver, the device, at 352, may be listening to BLE or iBeacon, as the case may be, broadcast or transmissions from a smartphone. Upon receiving such a data package, the receiver device may assess the header, at 354. Where the receiver device recognizes or verifies the header, the device, at 356, performs a decryption of the data package using the encryption key (or equivalently the decryption key) provided. After the decryption is complete, at 358, the receiver device checks whether the device ID that has been decrypted from the data package corresponds to the actual device ID of the receiver device. Once this has been verified, at 360, the receiver device executes the instructions or commands contained in the data package such as the command of the PWM, universal asynchronous receiver/transmitter (UART), which may typically be the RS-232C, timer (or timing information) or others. The UART may be used to interface to another micro controller, whereby the instructions received from the smartphone may be transferred to another multiple control unit (MCU) digitally for control over one or more devices.

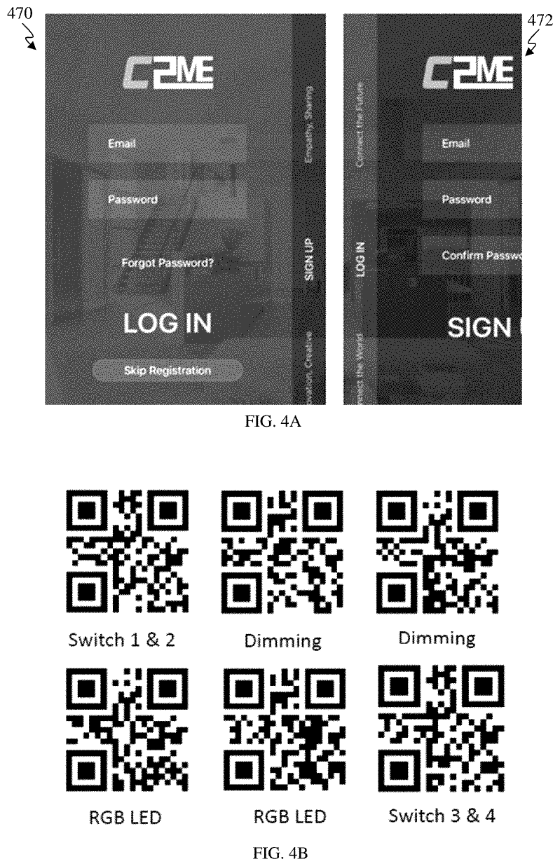

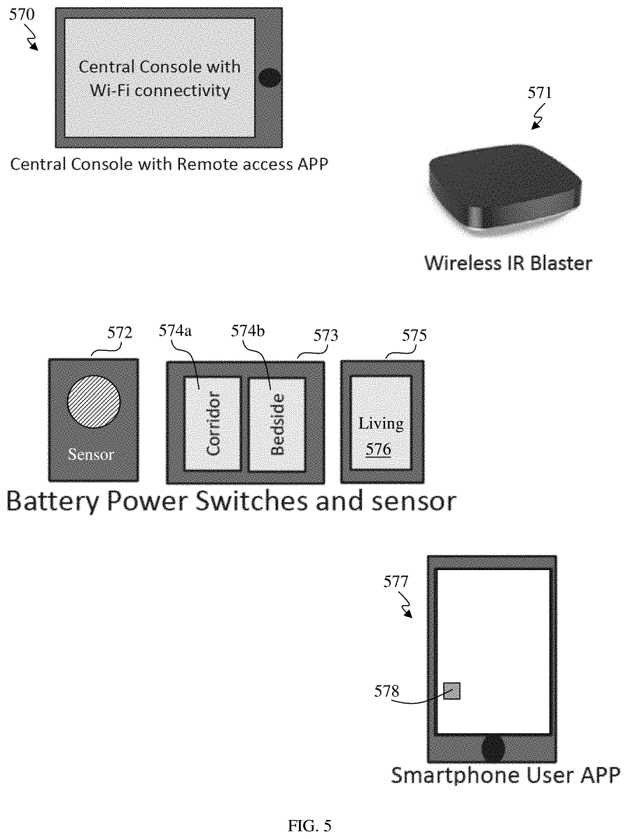

FIG. 4A shows images of screens for an application (app) of various embodiments, which may be shown upon activation of the app. A “Log In” screen 470 may be shown for a user of the app to log into an account of the user to control one or more associated or targeted devices (e.g., for situations where the user has already signed-up or registered for the account), or a “Sign Up” screen (shown partially) 472 may be shown so that a user may register for an account for controlling any targeted devices.

Once logged into the user's account, the user may control any targeted devices and their associated operations using the corresponding representations of the targeted devices. The user may also scan the QR code of a new target device such that a corresponding representation of the new target device may be created in the app, which may then allow the user to control the new target device and its associated operation via the app. In this way, by scanning the QR code of the associated target device and obtaining information therefrom, the device may then be “linked” to the user's account or app. Put in another way, the user's account or app may “see” or “recognise” the target device as a device that may be controlled via the app. Examples of QR codes for different devices, for example, switches, lighting (e.g., dimming lights, LEDs), etc., may be as illustrated in FIG. 4B.

Various embodiments may be employed in numerous applications or ecosystems including but not limited to smart homes, digital safes, digital keys (or key presses) and magnetic locks. Various embodiments may provide one or more of the following: (1) use of a smartphone to control a device/product without internet; (2) ease of setup without IT knowledge; (3) products are always RF silent before control; (4) access right capability to control the usage of products; (5) security access right by location, time and/or individual.

Some non-limiting examples of products that may be used as part of an ecosystem of various embodiments may include (i) wireless lighting or light source, for example, wireless light bulb (e.g., wireless (retrofit) RGBW light bulb), wireless light strip (e.g., wireless (6-meter) RGB light strip), which may be provided with a controller, wireless downlight, which may be provided with a controller; (ii) wireless switch (e.g., wireless ON/OFF light switch) with single (1)-, dual (2)-, or triple (3)-channel; (iii) wireless infrared (IR) blaster; (iv) wireless power adaptor.

FIG. 5 shows examples of apparatus that may form part of an ecosystem of various embodiments. These may include a central console or module with Wi-Fi connectivity and/or remote access app 570, a wireless infrared (IR) blaster 571, sensor 572 and battery powered switches (for example, a (dual-channel) switch panel 573 with switch 574a associated with a device (e.g., light) at a corridor, and switch 574b associated with a device (e.g., light) at a bedside), a (single-channel) switch panel 575 with switch 576 associated with a device (e.g., light) in a living room, and a user mobile device (e.g., a smartphone, tablet, etc.) 577 having the app (square 578 representing icon for the app) of various embodiments for controlling one or more target devices (e.g., light(s)).

The central console 570 may be able to allow remote access when the user is not physically in the vicinity or area of the controlled devices. The central console 570 may act as a gateway for remote access. Besides acting as remote access, it may perform higher level of control automation as the central console 570 may be linked to the internet, thus, may be able to execute pre-program information from a server.

The IR Blaster 571 may provide an RF to IR bridge solution or interface to support existing remote control devices such as for a television (TV) or air-conditioner. Through the IR blaster 571, the user may be able to use the app of various embodiments on a smartphone to send or broadcast a command RF signal to the IR Blaster 571, which, in turn, converts the RF signal to an IR signal to control the TV or air-conditioner.

For the ecosystem of various embodiments, for example, in hotels, no wiring may be needed for the switches and the (key) card holder. The card holder (or card switch) is a device where a (key) card may be inserted into, and is generally used as a master switch for hotel rooms. In various embodiments, the card holder may be employed as means to enable to rest of the switches to be controllable, else, all switches may be maintained in the “off” status if the corresponding card is not present or inserted into the card holder.

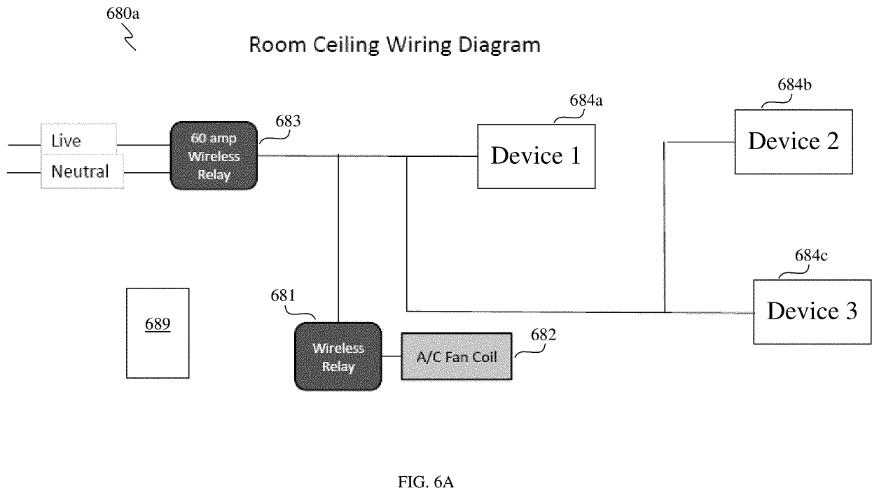

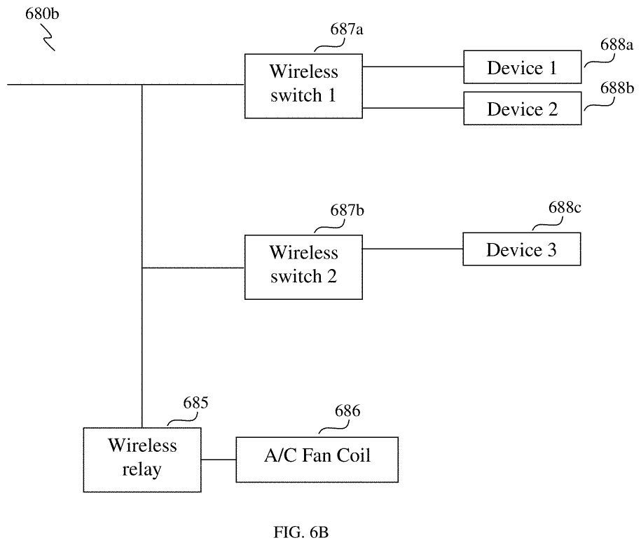

It should be appreciated that one or more of these apparatus as described in the context of FIG. 5 may be used in an ecosystem of various embodiments, where some non-limiting examples are described below with reference to FIGS. 6A and 6B.

FIG. 6A shows a schematic diagram illustrating part of a hotel ecosystem 680a, according to various embodiments, showing an example of room ceiling wiring. All apparatus as described in the context of FIG. 5 may be employed with the hotel ecosystem 680a. In the ecosystem 680a, a wireless relay 681 may be provided for operation with an air-conditioner (A/C) 682 or its associated fan coil. Another wireless relay (e.g., a 60 amp wireless relay) 683 may be provided for operation with one or more (wireless) devices, for example “Device 1” 684a, “Device 2” 684b, and “Device 3” 684c. A mobile device incorporating the app of various embodiments may be used to control any one of or each of the devices 684a, 684b, 684c and their associated operations. A battery-powered remote control 689 may be provided as part of the ecosystem 680a. As a non-limiting example, the relay 683 for controlling “Device 1” 684a, “Device 2” 684b, and “Device 3” 684c is wireless and may be positioned hidden in the ceiling, and the remote control 689 or a smartphone with the app of various embodiments may be used to control the “Device 1” 684a, “Device 2” 684b, and “Device 3” 684c. Thus, no wires are needed to run from “Device 1” 684a, “Device 2” 684b, and “Device 3” 684c to a physical switch. It should be appreciated that any number of devices may be employed in the ecosystem 680a. As non-limiting examples, each of the devices 684a, 684b, 684c may be a (wireless) light source, for example, a wireless RGBW light bulb.

FIG. 6B shows a schematic diagram illustrating part of a home ecosystem 680b, according to various embodiments, showing an example of a retrofit home automation system. The central console 570, the IR blaster 571, and the mobile device 577 as described in the context of FIG. 5 may be employed with the hotel ecosystem 680b. In the ecosystem 680b, a wireless relay 685 may be provided for operation with an air-conditioner (A/C) 686 or its associated fan coil. One or more wireless switches, for example “Wireless switch 1” 687a, and “Wireless switch 2” 687b, may be provided, for operation with one or more (wireless) devices, for example “Device 1” 688a, “Device 2” 688b, and “Device 3” 688c. A mobile device incorporating the app of various embodiments may be used to control any one of or each of the wireless switches 687a, 687b, and the devices 688a, 688b, 688c and their associated operations. In some embodiments, “Device 1” 688a, “Device 2” 688b, and “Device 3” 688c may be connected to the respective switches 687a, 687b, via one or more wires.

It should be appreciated that any number of wireless switches may be employed in the ecosystem 680b. Further, it should be appreciated that any number of devices may be operable with a wireless switch, for example, depending on the number of channels provided with the wireless switch. As non-limiting examples, each of the wireless switches 687a, 687b may be a wireless ON/OFF light switch. Further, as non-limiting examples, each of the devices 688a, 688b, 688c may be a (wireless) light source, for example, a (wireless) downlight.

A comparison of costs for new installation are illustrated in TABLES 1 and 2 below:

TABLE 1

| | Various | |
|---|---|---|
| Description | embodiments | Known system |
| Switches | USD30-50 | USD30-50 |
| Gateway | Nil | USD60-300 |
| Electrical installation | USD20/point | USD20/point |
| IT specialised installation per point | Nil | USD20/point |

TABLE 2
Example total cost for a house

| | Various | |
|---|---|---|
| Description | embodiments | Known system |
| Switches x20 points | USD600 | USD600 |
| Gateway | Nil | USD300 |
| Electrical installation | USD400 | USD400 |
| IT specialised installation per point | Nil | USD400 |
| Total | USD1000 | USD1700 |

Therefore, there may be a cost delta saving difference based on the technology of various embodiments against a known smart-home.

Generally, in order to prevent the receiver or receiving device (Rx) from decrypting every signal over the air, a header in the broadcast system is inserted. In this way, the header may act as an identifier to denote to the Rx that the associated signal is intended for the Rx. Using the header, the Rx is able to do a first pass filter to extract only the specific data on the air and perform a decryption. One challenge may be that there may be many receivers in a small area and there are a lot of broadcast signals from multiple transmitting devices. In this condition, a receiver may be overwhelmed by the different signals in the air, and in trying to determine which signal is for the receiver. Hence, it may cause the receiver to be overloaded, which may result in DoS (Denial of services). Thus, to prevent this scenario, it is preferable that the header for each signal being sent to the Rx is different.

In view of the above, various embodiments may further provide a dynamic header identifier for a receiver or receiving device (Rx). As a non-limiting example, the header for each signal being sent to (and intended for) a particular Rx may be different for signal(s) intended for another (different) receiving device (e.g., Rx“).

In order to have the header for one or more signals for each receiver to be different, various embodiments uses the receiving device ID (identifier) to generate the header needed for the receiver filter.

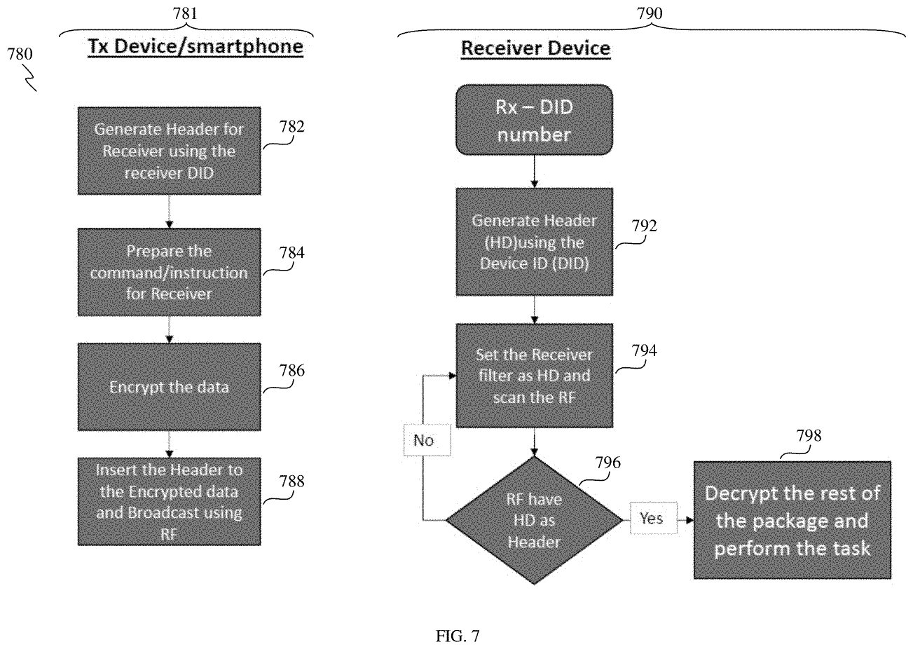

FIG. 7 shows a schematic diagram 780 illustrating flow charts 781, 790 for a method for generating a header, according to various embodiments. The flowchart 781 relates to the side of the transmitting device (e.g., a smartphone) (Tx), while the flowchart 790 relates to the side of the receiving device (Rx).

Referring to the flowchart 781 for a transmitting device (Tx), at 782, the Tx generates a header for signals for a (predetermined or intended or target) receiving device using the ID of the receiving device (DID). In various embodiments, each DID and/or header may be one or more numbers, or a set/sequence of numbers. As the header for a signal for a target Rx is based on the DID of that target Rx, the respective header broadcast or transmitted with the associated respective signal is not a fixed number for different signals intended for different receivers, but rather random numbers, relative to each other, broadcast or transmitted over the air. Such randomisation of the header is determined by the ID of the receiving device. This may mean that a (one) transmitter or transmitting device (Tx) may send data or signals with different headers for the corresponding different receiving devices, based on the ID of the respective Rx.

Different devices may have fixed different DIDs, e.g., DID 1 may be “88”, DID 2 may be “89”, and hence, the headers of signals for different receiving devices may be different as a result of the different DIDs of the receiving devices. The header for a signal intended for a target Rx may be fixed, to be associated with the DID of the target Rx. In known methods, signals that are transmitted, even if intended for different receiving devices, may have the same header.

At 784, the command/instruction for the target Rx may be prepared, e.g., in the form of a data signal (or stream or package). At 786, the data may be encrypted.

At 788, the header that has been generated may be inserted into the encrypted data and then broadcast using RF (radio frequency).

Referring to the flowchart 790 for a receiving device (Rx), the Rx has an associated DID number. At 792, a header (e.g., “HD”) may be generated using the DID. At 794, the filter for the RX may be set as HD and the Rx may then scan the RF signals broadcast through the air. In various embodiments, when the DID is programmed into the Rx or an associated module, the internal firmware of the Rx or module may automatically generate the header (“HD”) and use it as the RF filter.

At 796, the Rx may check whether a signal includes HD as its header. If it is determined that the header of the signal is not identical to HD, the Rx repeats the scanning process for signals. If it is determined that the header of the signal is identical to HD, the Rx may then, at 798, decrypt the signal or the rest of the data package, and carry out the task (e.g., instruction) provided with the data package. Therefore, for a signal intended for the target Rx, the signal includes HD as its header. Accordingly, it should be appreciated that the header generated by a Tx for a signal intended for a target Rx, using the DID of the target, and the header generated by the Rx using its DID, to be used as the Rx filter, are identical. This may mean that similar or like processes may be employed to generate the headers at both the Tx and Rx sides.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A device for controlling a target unit, the device comprising:
a processing module configured to broadcast a data stream comprising an identifying information for verification by the target unit and an instruction to the target unit for controlling the target unit.

2. The device as claimed in claim 1, wherein the processing module is configured to broadcast the data stream further comprising a timing information for verification by the target unit.

3. The device as claimed in claim 1 or 2, wherein the processing module is further configured to encrypt the data stream prior to broadcasting the data stream.

4. The device as claimed in any one of claims 1 to 3, wherein the processing module is configured to retrieve, from the target unit, an identifier associated with the target unit.

5. The device as claimed in any one of claims 1 to 4, wherein the processing module is configured to retrieve information from an optical code associated with the target unit.

6. The device as claimed in any one of claims 1 to 5, wherein the identifying information comprises a virtual identifier associated with a plurality of target units, and the processing module is further configured to broadcast the data stream to the plurality of target units simultaneously.

7. The device as claimed in any one of claims 1 to 6, wherein the device is configured to be in an RF silent mode prior to broadcasting of the data stream.

8. The device as claimed in any one of claims 1 to 7, wherein the processing module is configured to broadcast the data stream in compliance with a Bluetooth protocol or a Wi-Fi protocol.

9. The device as claimed in any one of claims 1 to 8, further comprising an application installed on the device, the application comprising processor-executable instructions for execution by the processing module, wherein the processing module is configured to execute instructions for broadcasting the data stream in response to activation of a user interface of the application.

10. A device for controlling a target unit, the device comprising:
a processor; and
a memory coupled to the processor, the memory having stored therein instructions, which when executed by the processor, cause the processor to broadcast a data stream comprising an identifying information for verification by the target unit and an instruction to the target unit for controlling the target unit.

11. A device for execution of an instruction in a data stream broadcast by an instructing unit, the device comprising:
a processing module configured to assess an identifying information comprised in the data stream for verification of the data stream to be intended for the device, and further configured, in response to the verification, to execute the instruction comprised in the data stream to operate the device.

12. The device as claimed in claim 11, wherein the processing module is further configured to verify a timing information comprised in the data stream.

13. The device as claimed in claim 11 or 12, wherein the processing module is further configured, in response to the data stream being in an encrypted form, to retrieve decryption information from the date stream for decrypting the data stream.

14. The device as claimed in any one of claims 11 to 13, further comprising an optical code capable of being read.

15. The device as claimed in any one of claims 11 to 14, wherein the device is configured to simultaneously interact with a plurality of data streams broadcast by respective instructing units.

16. The device as claimed in any one of claims 11 to 15, wherein a virtual identifier is defined for the device, the virtual identifier being common to at least one other device.

17. A device for execution of an instruction in a data stream broadcast by an instructing unit, the device comprising:
a processor; and
a memory coupled to the processor, the memory having stored therein instructions, which when executed by the processor, cause the processor to:
assess an identifying information comprised in the data stream for verification of the data stream to be intended for the device, and
in response to the verification, execute the instruction comprised in the data stream to operate the device.

18. A method for controlling a target unit, the method comprising:
broadcasting a data stream comprising an identifying information for verification by the target unit and an instruction to the target unit for controlling the target unit.

19. The method as claimed in claim 18, wherein broadcasting a data stream comprises broadcasting the data stream further comprising a timing information for verification by the target unit.

20. The method as claimed in claim 18 or 19, further comprising encrypting the data stream prior to broadcasting the data stream.

21. The method as claimed in any one of claims 18 to 20, wherein the identifying information comprises a virtual identifier associated with a plurality of target units, and wherein broadcasting a data stream comprises broadcasting the data stream to the plurality of target units simultaneously.

22. The method as claimed in any one of claims 18 to 21, wherein the method is RF silent prior to broadcasting the data stream.

23. The method as claimed in any one of claims 18 to 22, wherein broadcasting a data stream comprises broadcasting the data stream in compliance with a Bluetooth protocol or a Wi-Fi protocol.

24. The method as claimed in any one of claims 18 to 23, further comprising retrieving information from an optical code associated with the target unit prior to broadcasting the data stream.

25. The method as claimed in any one of claims 18 to 24, further comprising retrieving, from the target unit, an identifier associated with the target unit.

26. The method as claimed in any one of claims 18 to 25, further comprising generating a user interface on a device for controlling the target unit.

27. A method for a device for executing an instruction in a data stream broadcast by an instructing unit, the method comprising:
assessing an identifying information comprised in the data stream for verification of the data stream to be intended for the device; and
in response to the verification, executing the instruction comprised in the data stream to operate the device.

28. The method as claimed in claim 27, further comprising verifying a timing information comprised in the data stream.

29. The method as claimed in claim 27 or 28, further comprising, in response to the data stream being in an encrypted form, retrieving decryption information from the date stream for decrypting the data stream.

30. The method as claimed in any one of claims 27 to 29, further comprising simultaneously interacting with a plurality of data streams broadcast by respective instructing units.

31. An application adapted to be installed on a device, the application comprising processor-executable instructions for execution on the device to carry out a method as claimed in any one of claims 18 to 23.

32. The application as claimed in claim 31, wherein the processor-executable instructions comprise an instruction to retrieve information from an optical code associated with the target unit.

33. The application as claimed in claim 32, wherein the processor-executable instructions further comprise an instruction, in response to the information retrieved, to generate a user interface corresponding to the target unit.

34. A computer program or a computer program product comprising instructions which, when executed by a computing device, cause the computing device to carry out a method as claimed in any one of claims 18 to 26.

35. A device for controlling a target unit, the device comprising:
a processing module configured to broadcast a data stream in a radio frequency range, the data stream comprising an instruction to the target unit for controlling the target unit.

36. A device for execution of an instruction in a data stream broadcast in a radio frequency range by an instructing unit, the device comprising:
a processing module configured to execute the instruction comprised in the data stream to operate the device.

37. A method for controlling a target unit, the method comprising:
broadcasting a data stream in a radio frequency range, the data stream comprising an instruction to the target unit for controlling the target unit.

38. A method for a device for executing an instruction in a data stream broadcast in a radio frequency range by an instructing unit, the method comprising:
executing the instruction comprised in the data stream to operate the device.

39. An application adapted to be installed on a device, the application comprising processor-executable instructions for execution on the device to carry out a method as claimed in claim 37.

40. A computer program or a computer program product comprising instructions which, when executed by a computing device, cause the computing device to carry out a method as claimed in claim 37.
